(19) United States
(12) Patent Application Publication
(10) Pub. No.: US 2015/0019289 A1
(43) Pub. Date: Jan. 15, 2015

(54) System and Method for Forecasting Prices of Frequently-Promoted Retail Products

(71) Applicant: International Business Machines Corporation, Armonk, NY (US)

(72) Inventors: Ramesh Natarajan, Pleasantville, NY (US); Xiaoxuan Zhang, Park Ridge, NJ (US)

(73) Assignee: International Business Machines Corporation, Armonk, NY (US)

(21) Appl. No.: 13/961,358

(22) Filed: Aug. 7, 2013

Related U.S. Application Data
(63) Continuation of application No. 13/940,461, filed on Jul. 12, 2013.

(51) Int. Cl. G06Q 30/02

(52) U.S. Cl. CPC G06Q 30/0202
USPC 705/7.31

(57) ABSTRACT

Systems and methods for forecasting prices of products are provided. A method for forecasting prices of products, comprises obtaining a time series history of a price of a product, imputing a state indicator value for each price data from the time series history, wherein a state is one of a promotional price state and a regular price state, extracting a first price time series for the price data in the promotional state and a second price time series for the price data in the regular state, extracting a promotion duration time series from the time series history, obtaining respective point forecasts for the extracted first price time series, the second price time series and the promotion duration time series, and combining the point forecasts for the extracted first and second price time series and the promotion duration time series to obtain a final price forecast.

### CROSS-REFERENCE TO RELATED APPLICATION

This application is a Continuation of U.S. application Ser. No. 13/940,461, filed on Jul. 12, 2013, the disclosure of which is incorporated herein in its entirety by reference.

### TECHNICAL FIELD

The field generally relates to systems and methods for forecasting prices of retail products, and in particular, to forecasting prices of retail products that are subject to frequent price promotions, and for which the corresponding promotional price discounts and the promotion frequency may not be directly known, and/or may be subject to uncertainty.

### BACKGROUND

The retail price of frequently promoted products, such as fresh bread, usually varies within a range of regular price values, or within a range of promotional price values, and there may be frequent transitions between these two distinct price ranges. The promotional prices may typically be discerned to be a fixed discount on the prevailing regular price (e.g., 5%, 10%, etc.), or an adjustment towards a threshold price that is deemed attractive from a retail sales perspective (e.g., $4.99, $9.99, etc.). Furthermore, the nature of the transitions between the regular prices and the promotional prices may also be discerned to occur randomly, or with some periodic pattern, or deterministically around major holiday or marketing events, or in some combination of one or more of the above, that is, there may be some uncertainty alongside some reasonably predictable schedule for these transitions.

Known forecasting methods, such as exponential smoothing (ES) or auto-regressive integrated moving average (ARIMA) methods, which are described for example in G. E. P. Box and G. M. Jenkins, “Time series analysis: forecasting and control,” (Holden-Day, San Francisco, 1970), particularly in the absence of any information regarding the promotional events, will typically produce forecast estimates that will merely average the prevailing regular and promotional prices. As a result, these known methods will invariably fail to provide reasonable forecast estimates for such time series data. The basic reason for these poor forecast estimates is that in these known methods, the entire price history, which includes varying time periods of regular and promotion prices, is treated as a single time series for modeling and forecasting purposes. As a result, the point forecast estimates from these methods, at least for frequently promoted items, tend to be neither close to the actual regular price, nor close to the actual promoted price, but reflect some intermediate price value which represents an average of the prices in the promoted and non-promoted cases.

These traditional techniques may be difficult to improve upon in the case when the promotional schedule is completely random, or in the case when the periodicity of the promotional schedule is fixed or easily identifiable, or even specified in advance. However, in most practical cases, the promotion schedule is not perfectly random, is not fixed and easily identifiable, and is not specified in advance. Instead the promotional schedule has some predictable aspects, with superimposed stochastic behavior, and this structure motivates the need for the embodiments of the present invention.

### SUMMARY

In general, exemplary embodiments of the invention include systems and methods for forecasting prices of retail products and, in particular, to systems and methods for forecasting prices of retail products that are subject to frequent price promotions, and for which the corresponding promotional price discounts and the promotion frequency may not be directly known, and/or may be subject to uncertainty.

According to an exemplary embodiment of the present invention, a method for forecasting prices of products comprises obtaining a time series history of a price of a product, imputing a state indicator value for each price data from the time series history, wherein a state is one of a promotional price state and a regular price state, extracting a first price time series for the price data in the promotional state and a second price time series for the price data in the regular state, extracting a promotion duration time series from the time series history, obtaining respective point forecasts for the extracted first price time series, the second price time series and the promotion duration time series, and combining the point forecasts for the extracted first and second price time series and the promotion duration time series to obtain a final price forecast.

According to an exemplary embodiment of the present invention, a system for forecasting prices of products comprises a classification module capable of imputing a state indicator value for each price data from a time series history of a product, wherein a state is one of a promotional price state and a regular price state, an extraction module capable of extracting a first price time series for the price data in the promotional state and extracting a second price time series for the price data in the regular state, and extracting a promotion duration time series from the time series history, and a forecasting module capable of obtaining respective point forecasts for the extracted first price time series, the second price time series and the promotion duration time series, and combining the point forecasts for the extracted first and second price time series and the promotion duration time series to obtain a final price forecast.

According to an exemplary embodiment of the present invention, an article of manufacture comprises a computer readable storage medium comprising program code tangibly embodied thereon, which when executed by a computer, performs method steps for forecasting prices of products, the method steps comprising obtaining a time series history of a price of a product, imputing a state indicator value for each price data from the time series history, wherein a state is one of a promotional price state and a regular price state, extracting a first price time series for the price data in the promotional state and a second price time series for the price data in the regular state, extracting a promotion duration time series from the time series history, obtaining respective point forecasts for the extracted first price time series, the second price time series and the promotion duration time series, and combining the point forecasts for the extracted first and second price time series and the promotion duration time series to obtain a final price forecast.

These and other exemplary embodiments of the invention will be described or become apparent from the following detailed description of exemplary embodiments, which is to be read in connection with the accompanying drawings.

### BRIEF DESCRIPTION OF THE DRAWINGS

Exemplary embodiments of the present invention will be described below in more detail, with reference to the accompanying drawings, of which:

FIG. 1 is a high-level flow diagram of a method for forecasting prices of retail products according to an exemplary embodiment of the present invention.

FIG. 2 is a graph illustrating an example of a historic time series for the weekly-averaged prices of a frequently-promoted product, which is used in a method for forecasting prices of retail products according to an exemplary embodiment of the present invention.

FIG. 3 is a graph illustrating the state indicators for regular and promoted prices, which are determined and used in a method for forecasting prices of retail products according to an exemplary embodiment of the present invention.

FIG. 4 is a graph illustrating an extracted price time series out of the original price time series with the state indicator value of 0, according to an exemplary embodiment of the present invention.

FIG. 5 is a graph illustrating an extracted price time series out of the original price time series with the state indicator value of 1, according to an exemplary embodiment of the present invention.

FIG. 6 is a graph illustrating an extracted promotion duration time series, according to an exemplary embodiment of the present invention.

FIG. 7 is a graph illustrating point forecasts for the next 5 time periods after combining the forecasts of the two extracted price time series as well as the promotion duration time series, according to an exemplary embodiment of the present invention.

FIG. 8 is a high-level diagram of a system for forecasting prices of retail products according to an exemplary embodiment of the present invention.

FIG. 9 illustrates a computer system in accordance with which one or more components/steps of the techniques of the invention may be implemented, according to an exemplary embodiment of the invention.

### DETAILED DESCRIPTION OF EXEMPLARY EMBODIMENTS

Exemplary embodiments of the invention will now be discussed in further detail with regard to systems and methods for forecasting prices of retail products, and in particular, to forecasting prices of retail products that are subject to frequent price promotions, and for which the corresponding promotional price discounts and the promotion frequency may not be directly known, and/or may be subject to uncertainty. This invention may, however, be embodied in many different forms and should not be construed as limited to the embodiments set forth herein.

Embodiments of the present invention provide methods and systems for modeling the duration and intensity of promotional discounts as an intermittent process, and separately modeling the long-term drift and changes in the regular price using an appropriate time-series model. The embodiments of the present invention isolate the structural factors that are responsible for the behavior of the overall time-series for the price, and provide a potential automatic forecasting framework that can independently specify the appropriate additive or multiplicative trend, and seasonal components for each of these independent structural components.

As mentioned above, in many cases, information on the occurrence of price promotion events is not available and is not provided along with the historic sales time-series data. Therefore, this information must be implicitly inferred from the sales time-series data itself. For example, a specific retail entity such as a store, a chain, a warehousing facility, or a consumer goods manufacturer, may have access to the promotional calendar for its own products; however, in general, this retail entity will not have access to the same information for competitor products. Additionally, an entity may not even have the same information for many of its own products, which may have been subject to promotions by a third-party entity, or by a downstream entity in the retail supply chain. However, in most cases, by examining the historic sale times-series data for the relevant product obtained directly from retail point-of-sales data systems in the stores, or obtained from third-party aggregators of competitive retail data, it may be possible to discern regularities in the promotional patterns from the otherwise stochastic and noisy time-series sales data, through detailed analytical modeling, based on which a more accurate forecast for the prices can be obtained that incorporates the relevant promotional variations. As a result, an entity may be able to forecast demand for a product based on the entity's known pricing as well as price forecasts for the competitors' products.

The embodiments of the present invention provide a price forecasting method that is based on splitting the original historic time series into three individual time series, viz., the time series for the regular price, the time series for the promoted price, and the time series for the duration (or the transition frequency) between two successive promotions. In a method according to an embodiment of the present invention, the point forecasts for each of these three time series are obtained separately, using appropriate known methods, such as, for example, exponential smoothing or ARIMA methods. Then, using the forecast for the promotion inter-arrival time, it is forecasted whether the price in the next time period is in a regular price state or a promotional price state. A final forecast for this next time period is then taken as the point forecast estimate of the regular price time series if the next time period is in a regular price state with high probability. Alternatively, the point forecast is taken as the point forecast estimate of the promotional price time series if this next time period is in the promotional state.

By way of example, the embodiments of the present invention can be useful for making sales forecasts for short-shelf life product categories in a competitive retail environment were promotions may frequently be used, so as to capture consumer share from competing products, and to deplete excessive shelf inventory for products (such as products where freshness and timeliness of sales is critical, and products whose sales are driven by holidays/seasonal factors). In these cases, it is expected that customers may modify their purchase volumes and may change their purchase preferences based on promotions that are available, not only for a specified product, but also for competitor products in the same product category, or even towards the more recent stock of the same product where freshness is an important factor. Therefore, the customer demand may be based on demand shifting among competitive products and brands, or demand shifting within the inventory stock for the same product. The use of known uni-variate time series methods is unsuitable for this data, particularly when the relevant promotional data is not available and it is not impossible to model the more important factors that are responsible for the frequency and size of the price promotions.

Some known methods for retail demand forecasting that are embodied in commercial software products attempt to model future product demand assuming that the future sequence of product prices are known; however, as noted earlier, this assumption is not plausible for competitor products, whose pricing and promotion strategies will generally not be available, even though some inferences may be made on these pricing and promotion strategies from the historic price time series data that may be available from third-party aggregators of retail sales data.

Known methods for forecasting with so-called “intermittent-demand” products, that is, products whose base demand is low and steady, but interspersed with peaks of moderate to high demand, are potentially effective in forecasting demand for intermittent products, but are limited by several considerations if extended to the forecasting prices of intermittently-promoted products. Other known methods involve the use of dynamic models for price mode switching between the regular and promotion states to model the mode switching dynamics, specifically the mode switching probability. This mode switching probability, which is a function of the price state and the duration in the current price state, defines a model for the dynamics of the transitions between the price states. The price forecast is then a probability-weighted average of price trends in the regular and promoted states. The limitations of this forecasting approach in the prior art, which are addressed by the embodiments of the present invention, are two-fold. First, the relevant state space is infinite dimensional, and therefore, a finite time-series sample of historic data may often be insufficient for sampling a reasonable-sized fraction of the states from this infinite dimensional state space. Second, the use of the probability-weighted averages of the time-series trends in the regular and promoted price states leads to price forecasts that always overestimates or underestimates of the actual prices.

As stated above, the embodiments of the present invention pertain to methods for modeling and forecasting the retail prices of frequently-promoted products, with particular interest in the case when the promotion discounts and promotion periods are not explicitly known but must be inferred from the data. In particular, the embodiments may be used for carrying out the price modeling and forecasting of competitor products. Exemplary embodiments transform the single price time series to obtain a multiplicity of time series; these correspond respectively to the time series of the indicators of the product in the regular and promoted states, the time series of the details of the historical price time series in each of the regular and promoted states, the time series of the durations between the transitions from regular to promoted price states and vice-versa, and the time series of the size of the promotional discount. The embodiments of the present invention separately apply appropriate time-series modeling and forecasting procedures to the multiplicity of time series set forth above, in particular to the time series of prices in the regular and promoted states, and the time series of the durations in the regular and promoted price states. According to an embodiment, the modeling and forecasting procedures are further applied to the time series of the magnitude of the promotional discounts. These models and forecasts are then appropriately combined to generate forecasts for future price and promotion schedules in terms of the forecasts of the price in each state time series, price change intervals and promotional discount forecasts as obtained separately.

As a result, more reliable forecast estimates may be obtained from the historic price time-series data by estimating the promotion price discounts and promotion frequency using the method steps of the embodiments of the present invention, thereby significantly improving the retail price prediction that is provided to a variety of retail decision support applications used for supply chain, inventory management and pricing, wherein the effectiveness of these retail decision support applications may require an accurate specification and forecasting of the future prices of retail products for products that are subject to unknown but frequent retail promotions and price discounts.

A particular example is described herein in which the embodiments of the invention were used to model and forecast the retail prices of products in a packaged-food retail category. However, it is to be understood that the embodiments of the present invention are not limited thereto, and may be applied to other retail categories, or to wholesale categories in certain situations.

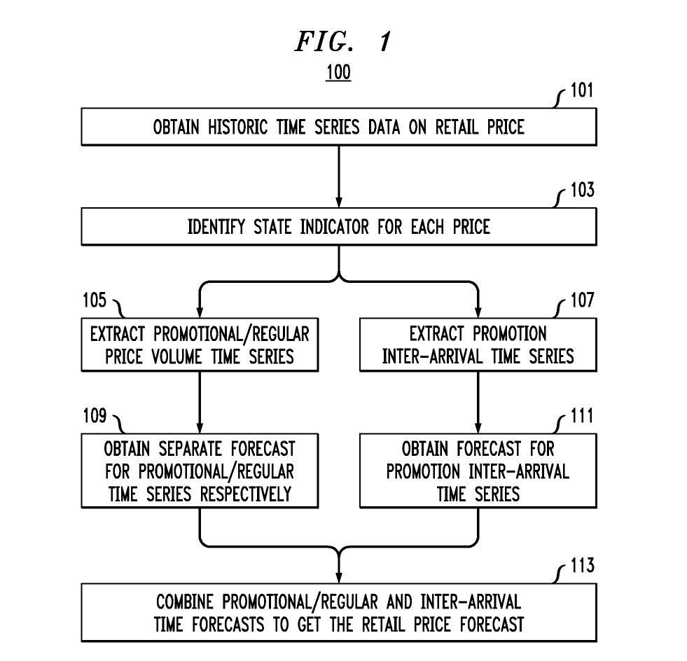

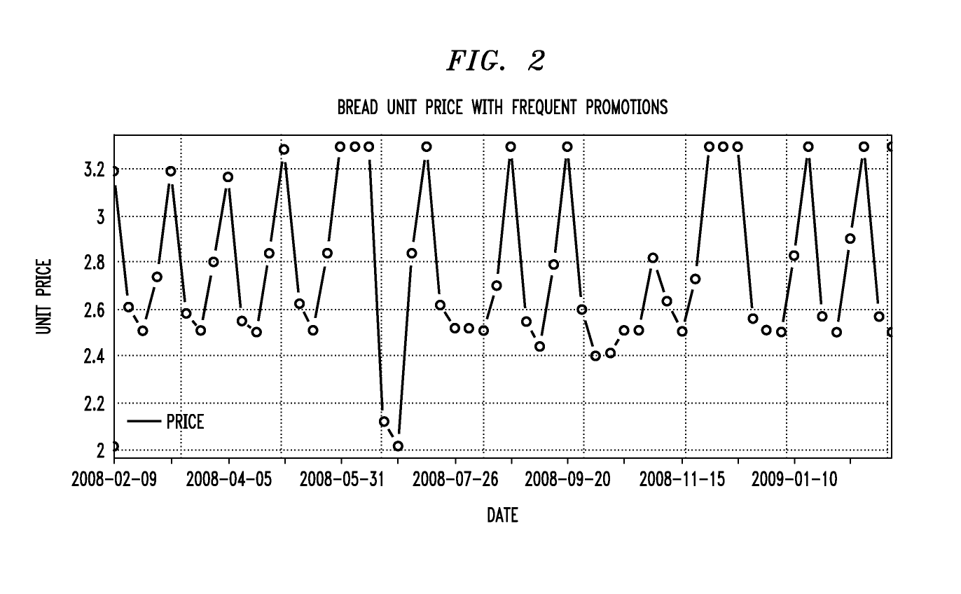

FIG. 1 is a high-level flow diagram of a method for forecasting prices of retail products according to an exemplary embodiment of the present invention, wherein forecasting procedures are based on the availability of a time series of historic price data. FIGS. 2-7 illustrate an example for one such time series of historic price data that is suitable for representing method steps of the embodiments of the invention.

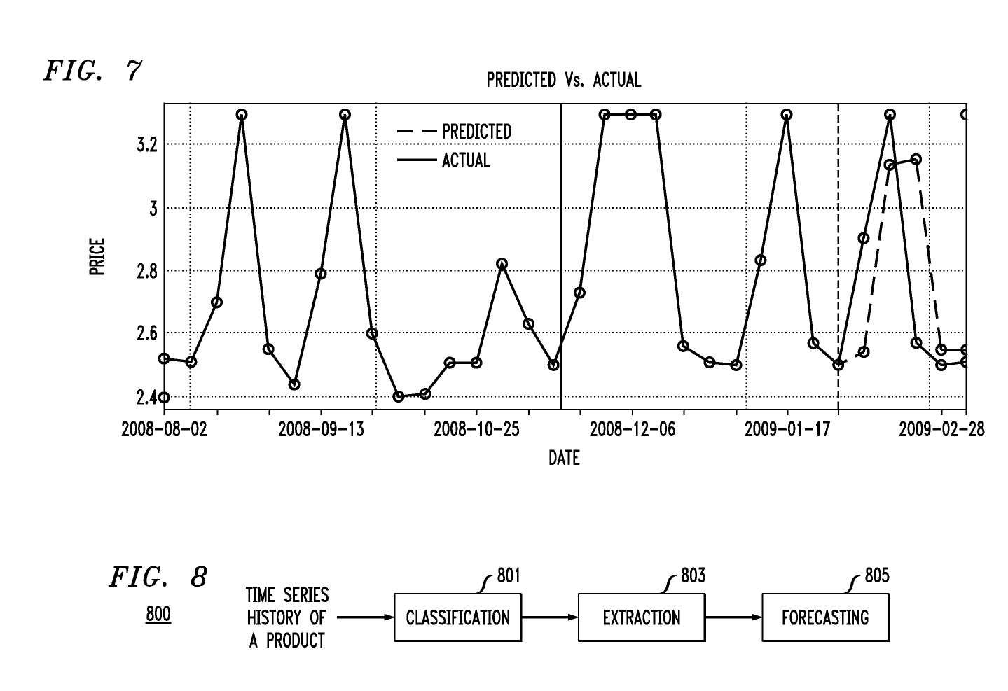

At block 101, input data to the forecasting engine, which is the time series history of the known retail price of the given product, is obtained from, for example, point-of-sales (POS) systems, billing systems or inventory systems. At block 103, the state indicator value (e.g., 0 indicates promotional state and 1 indicates regular price state) is imputed for each price data using heuristic methods. An example of such a heuristic method identifies the state transitions by calculating the one-step percentage change in the running retail prices, and using threshold values for these percentage changes to identify transitions between the promotional and regular price states. After imputing this state indicator, the method further comprises extracting the price time series for each state (i.e., promotional and regular) corresponding to the indicator values imputed from the original price time series (block 105). The method also comprises obtaining the duration for which the price stays in the promotion state, i.e., extracting the promotion duration (inter-arrival) time series (block 107). Then, the point forecasts for each extracted price time series in the regular and promoted states (block 109), as well as the promotion duration time series (block 111) are then obtained using standard known time series forecasting techniques such as exponential smoothing methods, and ARIMA (see, e.g., G. Box and G. Jenkins, Time series analysis: Forecasting and control, San Francisco: Holden-Day (1970); P. J. Brockwell and R. A. Davis, Time Series: Theory and Methods. Springer-Verlag (1987)). The final price forecast is provided by combining all these point forecasts of each separate time series (block 113). For example, if the duration forecast is higher than the most recent promotion duration value, which means that the next price state would still be the promotion state, then the final price forecast would be equal to the point forecast of the promotion price time series, and vice versa. For example, referring to FIG. 7, to the right of the dotted line, the first predicted price state was determined to still be in the promotion state because the duration forecast was greater than the last promotion duration value (note that the promotion duration value is measured from the time when the current promotion state was entered, e.g., referring to FIG. 7, this occurs one state before the dotted line). As a result, the first predicted price state after the dotted line in FIG. 7 was the promotion state, and hence was assigned the point forecast value of the promotion price time series

Accordingly, an embodiment of the present invention discloses a computer-implemented method for the modeling of cyclical demand systems in the presence of dynamic controls or dynamic incentives, the method comprising:

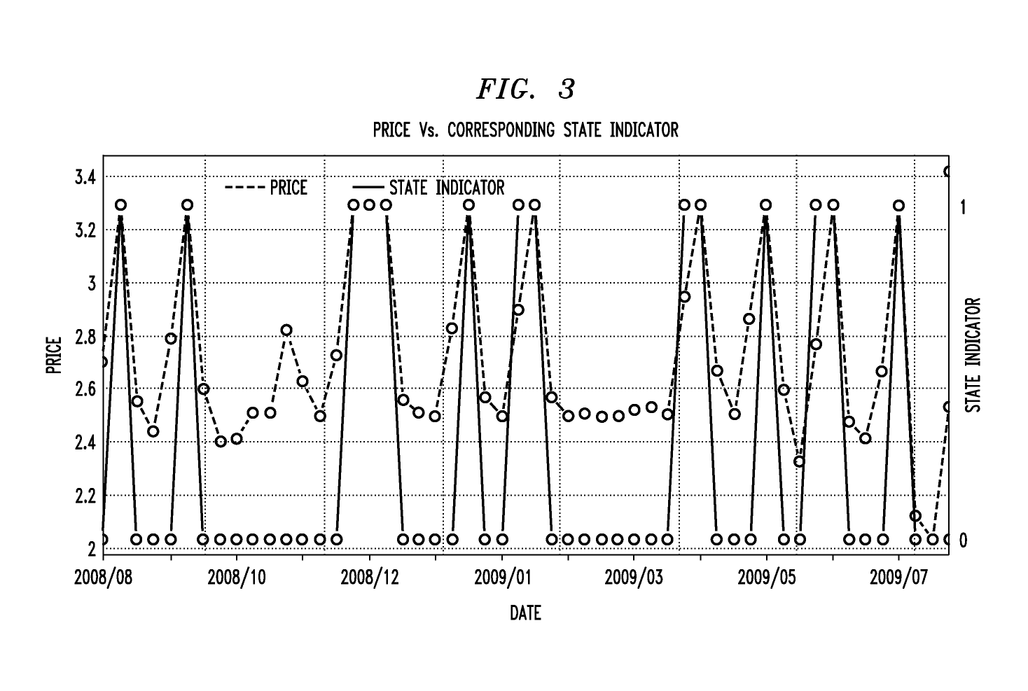

1. Heuristic analysis of an original retail price time series and detecting whether the price at each time period is a promotional or regular price. The heuristic analysis may include detecting the percentage of price change from one time period to another, or clustering the price levels and partitioning the resulting clusters into regular and promotional price levels (see e.g., FIGS. 2 and 3; and blocks 101 and 103 of FIG. 1).

2. The transformation of the original retail price time series into the 0/1 state indicator time series, where 0 represents the price in the promotional state, and 1 represents the price is a regular (non-promotional) price (see e.g., FIG. 3).

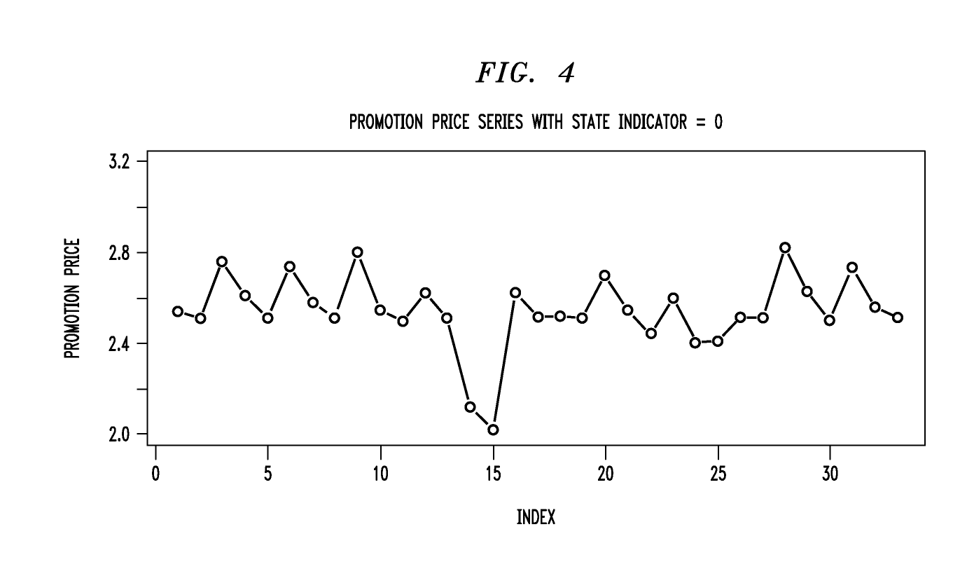

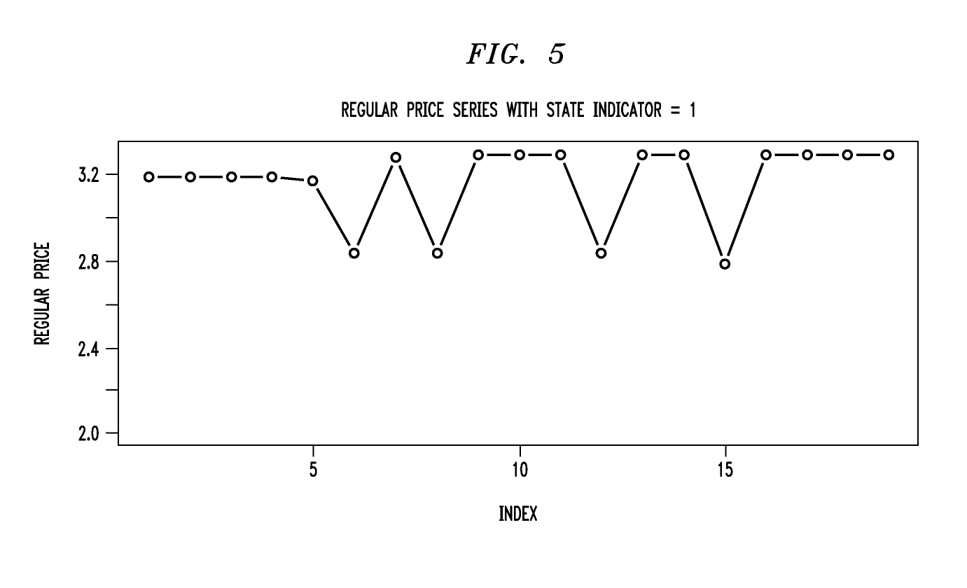

3. The extraction of the promotional/regular price time (sub) series out of the original retail price time series according to whether the transformed state indicator equals to 0 or 1 respectively (see e.g., FIGS. 4 and 5; and block 105 of FIG. 1).

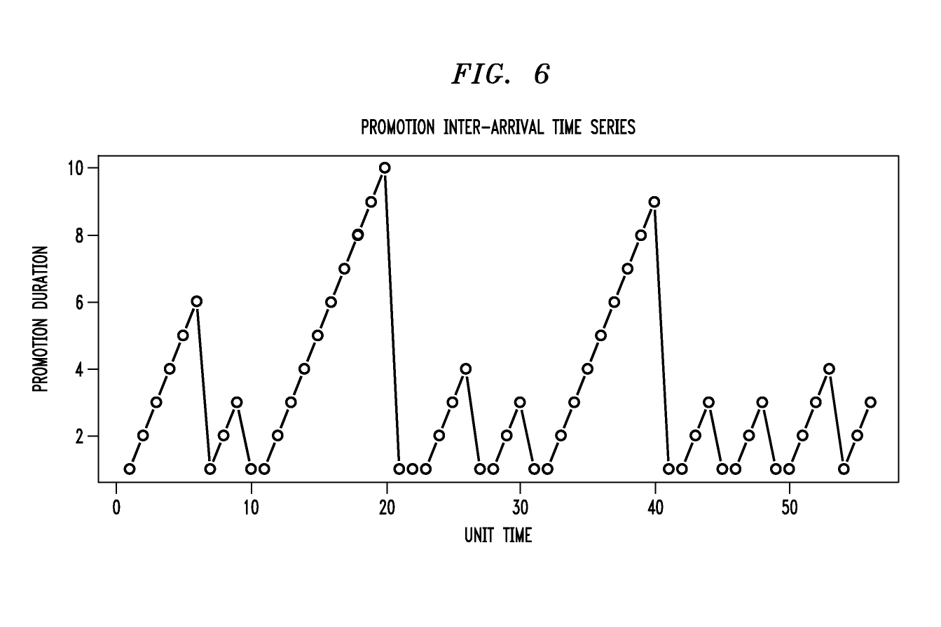

4. The calculation of the time series for the promotion duration based on the number of time intervals for which the state indicator has been in the 0 state (see e.g., FIG. 6; and block 107 of FIG. 1).

5. The forecasting of the promotional and regular prices from the extracted promotional and regular time series of prices using known time series forecasting methods, including methods that incorporate trend and seasonality effects, if necessary, for each time series (see e.g., block 109 of FIG. 1). Here trend and seasonality refer to predictable linear or periodic variations over time respectively that can be explicitly captured in the time series modeling procedure. The incorporation of trend and seasonality in these time series models can follow approaches that are well developed in the prior art (see, e.g., P. J. Brockwell and R. A. Davis, Time Series: Theory and Methods. Springer-Verlag (1987)), where the trend is the sloping line fit to the time series, and the seasonal components are the constant variations depending only on the seasonal period (e.g., quarterly, monthly, weekly etc.) adjusted to the time series.

6. The forecasting of the promotion duration from the extracted promotional duration time series is performed using known time series forecasting methods, including methods that incorporate trend and seasonality effects if necessary (see e.g., block 111 of FIG. 1). It is to be understood that the forecasting method used for each time series is not constrained to exponential smoothing (ES) or auto-regressive integrated moving-average (ARIMA), but can also use more general dynamic models for non-stationary time series. In addition, embodiments of the invention also include the case where neither trend nor seasonality effects are incorporated in the forecasting. For example, an exemplary embodiment using Formulas (2) and (3) described below excludes trend and seasonality effects.

7. The combination of the three forecasts into the final price forecast. In particular, if the duration forecast is higher than the most recent promotion duration value, which means that the next price state would still be the promotion state, then the final price forecast would equal to the point forecast of the promotion price time series, and vice versa (see e.g., block 113 of FIG. 1).

FIG. 2 is a graph illustrating an example of historic time series for the weekly-averaged prices of a frequently-promoted grocery product that can be obtained at block 101. FIG. 2 shows that the price tends to jump between a low price of about 2.5 and a regular price of about 3.2, and tends to remain at the regular price for a longer period than at the low price, although the time spent in the low price period also tends to persist for a few weeks.

FIG. 2 illustrates an example of data where the method steps of an embodiment of the invention can be applied, wherein the price time series, recorded weekly, for a packaged fresh food product is displayed for a period of one year. It can be discerned that the price time series frequently jumps between a price level around 2.5 which is representative of the promoted price, and a price level around 3.2 which is representative of the regular price. The price can be seen to remain for several weeks at the lower promotion price levels, which is presumably a consequence of the promotion policy used by the retailer or manufacturer to, for example, deplete the unsold inventory of fresh food products which tend to have a short shelf life, and low salvage value for the unsold inventory. It is to be understood that the embodiments of the present invention are not limited to fresh food products, and may be applied to other food or non-food products.

FIG. 3 is a graph illustrating the state indicator for regular and promoted prices, which is estimated for each week in the historic time series using certain heuristic methods as per block 103 in FIG. 1. The time series of the state indicators is imputed from the price time series using certain heuristics. Referring to FIG. 3, the state indicator is equal to 0 (promotion state) for most prices in the lower price level around 2.5, and equal to 1 (regular state) for most prices in the upper price level around 3.2. In accordance with an embodiment of the present invention, the heuristic process for obtaining the state indicator time series classifies the original price time series into two clusters (e.g., promotional and regular), and represents the transition process between the regular and promotion prices. For instance, in one exemplary embodiment, such a heuristic may comprise of the steps of initially identifying such local maxima and minima in the time series unit-price data that are clearly and unambiguously associated with the regular and promotional price states; and, then using a clustering approach to assign regular or promotion price states to the remaining sales reporting periods for which such an unambiguous association is not possible.

It is to be understood that although 2 states are shown in accordance with embodiments of the present invention, the embodiments are not limited thereto, and, for example, more than 2 price states may be analyzed when pricing occurs at more than two levels. Accordingly, modeling can be performed using multiple states.

In connection with block 105 in FIG. 1, FIG. 4 is a graph illustrating the extracted time series out of the original time series of historic prices for the case when the state indicator is equal to 0. In particular, the graph in FIG. 4 corresponds to the price time series at the promotion price from FIGS. 2 and 3, which is a subset of the original time series for which the corresponding state indicator has been imputed to be 0.

Also, in connection with block 105 in FIG. 1, FIG. 5 is a graph illustrating the extracted price time series out of the original price time series for the case when the state indicator is equal to 1. In particular, the graph in FIG. 5 corresponds to the price time series at the regular price from FIGS. 2 and 3, which is the subset of the original time series for which the corresponding state indicator has been imputed to be 1.

In connection with block 107 in FIG. 1, FIG. 6 illustrates the extracted promotion duration (inter-arrival) time series. The initial duration value is set to 1. If the next state indicator equals 1 (regular price), then the duration value remains at 1, or returns to 1 from a value higher than 1 as shown by the decline from a peak. However, if the next state indicator is 0 (promotion price), then the duration value increases by 1. Iterating this step over the entire time series for the state indicators provides the resulting promotion duration time series. For example, referring to FIG. 6, the promotion durations over the first 10 time units (e.g., weeks) are 6 and 3 time units (e.g., weeks), over the next 10 time units the promotion duration is 10, and over the next 10 (from 20 to 30), the promotion durations are 4 and 3 time units. From studying a graph of the inter-arrival time series, a promotional pattern may be able to be discerned.

In connection with block 113 in FIG. 1, FIG. 7 is a graph illustrating the point forecasts that are obtained for 5 ensuing time periods, obtained by combining the forecasts of the two extracted price time series (from block 109), as well as the forecasts of the promotion duration time series (from block 111). In FIG. 7, the 5 points to the right of the dotted line show the forecasts versus the actual prices. The points to the left of the dotted line represent the historical time series used in arriving at the forecasts.

In particular, the method steps of an embodiment of the present invention provide the point forecast of the promotional-price time series (block 109), the point forecast of the regular-price time series (block 109), as well as the point forecast of the promotion-duration time series (block 111). In accordance with an embodiment, known time series forecasting methods such as exponential smoothing (ES) or autoregressive integrated moving average (ARIMA), are used to provide the above point forecast values. The final price forecast shown in FIG. 7 is obtained by combining these respective point forecasts for each separate time series in an appropriate fashion (block 113). In particular, according to an embodiment of the present invention, if the duration forecast is higher than the most recent promotion duration value, which suggests that the next price state would still be the promotion state, then the final price forecast is given by the point forecast of the promotion-price time series; alternatively, if the duration forecast is lower than the most recent promotion duration value, which suggests that the next price state would no longer be in the promotional state, then the final price forecast is given by the point forecast of the regular-price time series.

Referring back to FIG. 1, the method for forecasting prices of retail products according to an exemplary embodiment of the present invention is quantitatively specified as follows:

$$\begin{matrix}{P}_{{t}_{i}}^{i} = {P}_{t} , if {x}_{t} = i , i = 0 , 1 & ( 1 ) \\ {\hat{P}}_{{t}_{0} + 1}^{0} = {α}_{0} {P}_{{t}_{0}}^{0} + ( 1 - {α}_{0} ) {\hat{P}}_{{t}_{0}}^{0} & ( 2 ) \\ {\hat{P}}_{{t}_{1} + 1}^{1} = {α}_{1} {P}_{{t}_{1}}^{1} + ( 1 - {α}_{1} ) {\hat{P}}_{{t}_{1}}^{1} & ( 3 ) \\ {τ}_{t + 1} = {α}_{2} {τ}_{t} + ( 1 - {α}_{2} ) {τ}_{t} & ( 4 ) \\ {P}_{T + 1} = \{ \begin{matrix}{\hat{P}}_{{T}_{0} + 1}^{0} , & if {\hat{τ}}_{T + 1} \leq {τ}_{T} + 1 \\ {\hat{P}}_{{T}_{1} + 1}^{1} , & otherwise\end{matrix} & ( 5 )\end{matrix}$$

where T, T₀, T₁ are the total number of time periods for the original and extracted price series, Pₜ⁰, Pₜ¹, τₜ are promotion price, regular price and promotion inter-arrival time series respectively, and denote the predicted values.

The α₀, α₁ and α₂ in Formulas (2) to (4) represent the smoothing parameters in the exponential smoothing models for the promotion price, regular price, and promotion duration time series respectively, whose values are calibrated from historical data using methods that are well known in the prior art. The t₀, t₁ in Formulas (2) and (3) represent the time steps within the promotion price and regular price time series respectively, while the t in Formulas (1) and (4) represent the time steps in the original time series comprising both promotion and regular prices (i.e., before extraction). The T₀, T₁ and T values in Formula (5) represent the index for the rolling horizon of time series values at the forecast instant for the promotion price, regular price, and overall time series respectively (note that T₀+T₁=T).

In particular, Formula (1) is used to extract the time series for the regular and promotion prices from the original price time series (Block 105). Formula (2) is an example of an embodiment of the present invention using exponential smoothing to provide point forecasts for promotional price time series as in block 109. Formula (3) is an example of an embodiment of the present invention using exponential smoothing to provide point forecasts for regular price time series as in block 109. Formula (4) is an example of an embodiment of the present invention using exponential smoothing for forecasting the promotion duration for the next time period as in block 111. Formula (5) provides the details of the steps used for combining the price forecasts for the regular and promotion time series with the forecast for the promotion duration time series as in block 113 according to an embodiment of the present invention. In particular, if the forecast for the duration is higher than the most recent promotion duration value, wherefrom the next price state would be forecast to still be the promotion state, then the corresponding price forecast would equal the point forecast of the promotion price time series; alternatively, if the duration forecast is lower than the most recent promotion duration value, wherefrom the next price state would be forecast to no longer be in the promotional state, then the corresponding price forecast would equal the point forecast of the regular price time series.

It is to be understood that the embodiments of the present invention are not necessarily limited to the time series forecasting algorithms referred to in (1)-(5) and may incorporate other time series forecasting algorithms.

In accordance with an embodiment of the present invention a method for forecasting regular and promotion prices of a retail product includes transforming a single price time series to obtain a multiplicity of time series corresponding to the time series of state indicators of the regular and promoted states, the time series of the historical prices in each state, the time series of the duration between the transitions from regular to promoted price and vice-versa, and the time series of the magnitude of the promotional discount. In some embodiments, obtaining the time series of the magnitude of the promotional discount is optional (in order to see this, note that the time series for the magnitude of the promotional discount is essentially equivalent to, and can be obtained from simple mathematical operations, on the time series of prices in the regular and promoted states; therefore, any two out of these three time series is required, and the third is then optional). Time-series procedures for modeling and forecasting are applied to the multiplicity of time series respectively corresponding to the prices in the regular and promoted states, the duration of the transitions of the price states, and the magnitude of the promotional discounts if included. Forecasts of future price/promotion schedules are generated by combining the individual and separately-obtained forecasts of the prices in each price state, the forecasts of the duration of the price change intervals, and, if included, the forecasts of the magnitude of the promotional discounts.

Transforming the single price time series to obtain a multiplicity of time series corresponding to the time series of state indicators of the regular and promoted states can include classifying a value in the time series for the price, using a clustering and partitioning procedure to infer the unknown state indicator for the price, where the price may be in either the regular or promoted states, assigning the state indicator for individual prices in the time series of price values to the regular and to promoted state values, and extracting the time series in the regular state and in the promoted state, respectively. Modeling and forecasting the prices in the regular and promoted states can include using any of known time series forecasting methods, and these methods may include known enhancements for incorporating mean shifts, trends, seasonality, and holiday effects for the prices in the individual price time series. Modeling and forecasting the time series of the duration of the transitions between the price states can include using linear and/or logistic regression. Modeling and forecasting the time series of the magnitude of the promotional discounts can include using linear regression.

Forecasts of future price/promotion schedules can be generated by combining the individual and separately-obtained forecasts of the prices in each price state, and the forecasts of the duration of the price change intervals, and, according to an embodiment, the forecasts of the magnitude of the promotional discounts. Combining the point forecasts of the regular and promotional price time series as well as point forecast of the promotion duration time series can include providing the point forecast of the promotional price sub time series, and the point forecast of the regular price sub time series, as well the point forecast of the promotion duration time series. As noted earlier, known time series forecasting methods could be used to provide the above point forecast values. The final price forecast can be provided by combining each of the above point forecasts of each separate time series. In particular, if the duration forecast is higher than the most recent promotion duration value, which means that the next price state would still be the promotion state, then the final price forecast would equal the point forecast of the promotion price sub time series. However, if the duration forecast is lower than the most recent promotion duration value, which means that the next price state would no longer be in the promotional state, then the final price forecast would equal to the point forecast of the regular price sub time series.

Future price/promotion schedules could be obtained by recalculating and updating the time series of indicators corresponding to the price states, and recalculating and updating the time series of price changes, in order to obtain the required one-step forward forecasts.

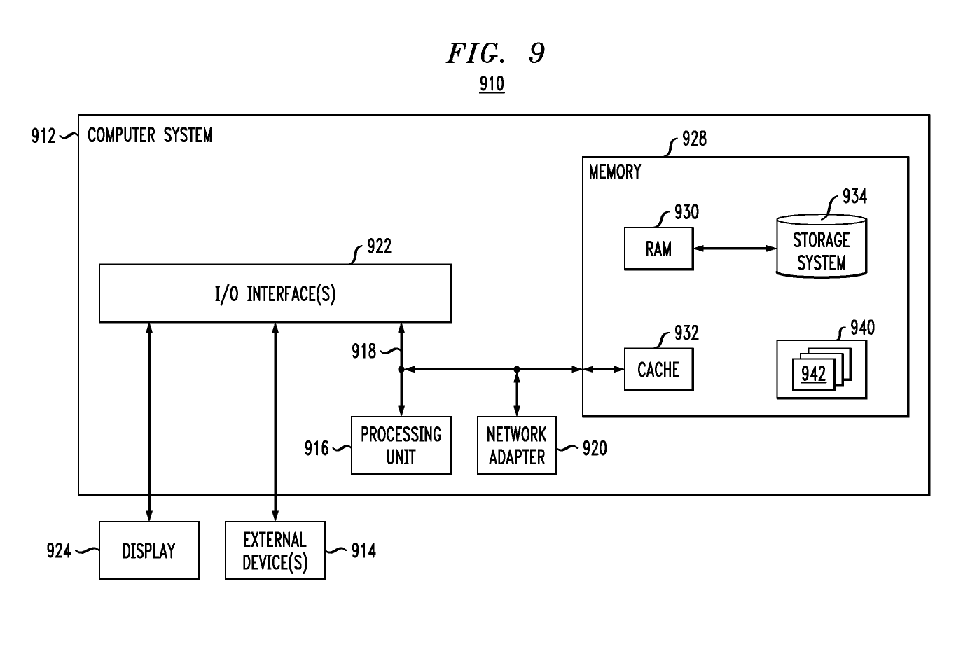

Referring to FIG. 8, a system 800 for forecasting prices of products, in accordance with an embodiment of the present invention, comprises a classification module 801, an extraction module 803, and a forecasting module 805. Given a time series history of a product, the classification module 801 imputes a state indicator value (e.g., 0 and 1) for each price data from a time series history of a product. The state, according to an embodiment, is a promotional price state or a regular price state. The classification module can use heuristic methods to impute the state indicator values. The heuristic methods may comprise clustering price levels and partitioning resulting clusters into the regular and promotional states.

The extraction module 803 extracts a promotional price time series for the price data in the promotional state and a regular price time series for the price data in the regular state, and extracts a promotion duration time series from the time series history. In order to extract the promotion duration time series, the extraction module is capable of determining a number of time intervals for which the state indicator value is in the promotional state. In accordance with an embodiment of the present invention, the extraction module is also capable of extracting a time series of a magnitude of a promotional discount from the time series history.

The forecasting module 805 obtains respective point forecasts for the extracted first price time series, the second price time series and the promotion duration time series, and combines the point forecasts for the extracted first and second price time series and the promotion duration time series to obtain a final price forecast. In order to obtain respective point forecasts for the extracted first price time series, the second price time series and the promotion duration time series, the forecasting module 805 can use known time series forecasting methods including methods that incorporate trend and/or seasonality effects, if necessary, for each time series. In order to combine the point forecasts for the extracted first and second price time series and the promotion duration time series, the forecasting module 805 can compare the point forecast for the promotion duration time series to a value of the most recent promotion duration at a time instant where the final price forecast is being made. The forecasting module 805 determines if the point forecast for the promotion duration time series is greater than the most recent promotion duration value, and, if so, concludes that a next predicted price is in the promotion state, and is equal to the point forecast of the promotion price time series. In the alternative, the forecasting module 805 determines if the point forecast for the promotion duration time series is less than the most recent promotion duration value, and, if so, concludes that a next predicted price is in the regular state, and is equal to the point forecast of the regular price time series.

### Experimental Example

Method steps of an embodiment of the present invention were performed in the context of modeling of a retail price forecast for a product in a retail product category corresponding to a frequently-promoted, high sales volume, packaged-food staple. The historical data was obtained for this category in some retail stores.

In this example, the price values are the retail unit price values for a history period of 3 years. The history price time series were collected from different stores for a certain retail chain in a single geographic market. The historical time series of the price data, which was obtained from a third-party retail sales aggregator, included the prices for the products whose promotion policy was known to the client performing the price forecasting analysis, but also included the prices for competitor's products whose promotion policies were not known to the client, and therefore subject to uncertainty. It was discerned that the knowledge of the competitor's promotional policy is an important component for determining market share, and plays a critical role in decision support applications in the retail applications for pricing, inventory and manufacturing requirements.

The embodiments of the present invention generally relate to a method and system for modeling and forecasting the prices of frequently-promoted retail products, and can be especially relevant when the promotion frequency and promotion discounts are not explicitly known; for example, this would be the case for competitor products, whose promotion policies are not known but significantly influence the retail demand for all products in the retail category.

As will be appreciated by one skilled in the art, aspects of the present invention may be embodied as a system, apparatus, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

FIGS. 1-8 illustrate the architecture, functionality, and operation of possible implementations of systems, methods, and computer program products according to various embodiments of the present invention. In this regard, each block in a flowchart or a block diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagram and/or flowchart illustration, and combinations of blocks in the block diagram and/or flowchart illustration, can be implemented by special purpose hardware-based systems that perform the specified functions or acts, or combinations of special purpose hardware and computer instructions.

One or more embodiments can make use of software running on a general-purpose computer or workstation. With reference to FIG. 9, in a computing node 910 there is a computer system/server 912, which is operational with numerous other general purpose or special purpose computing system environments or configurations. Examples of well-known computing systems, environments, and/or configurations that may be suitable for use with computer system/server 912 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 912 may be described in the general context of computer system executable instructions, such as program modules, being executed by a computer system. Generally, program modules may include routines, programs, objects, components, logic, data structures, and so on that perform particular tasks or implement particular abstract data types. Computer system/server 912 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 912 in computing node 910 is shown in the form of a general-purpose computing device. The components of computer system/server 912 may include, but are not limited to, one or more processors or processing units 916, a system memory 928, and a bus 918 that couples various system components including system memory 928 to processor 916.

The bus 918 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer system/server 912 typically includes a variety of computer system readable media. Such media may be any available media that is accessible by computer system/server 912, and it includes both volatile and non-volatile media, removable and non-removable media.

The system memory 928 can include computer system readable media in the form of volatile memory, such as random access memory (RAM) 930 and/or cache memory 932. The computer system/server 912 may further include other removable/non-removable, volatile/nonvolatile computer system storage media. By way of example only, storage system 934 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus 918 by one or more data media interfaces. As depicted and described herein, the memory 928 may include at least one program product having a set (e.g., at least one) of program modules that are configured to carry out the functions of embodiments of the invention. A program/utility 940, having a set (at least one) of program modules 942, may be stored in memory 928 by way of example, and not limitation, as well as an operating system, one or more application programs, other program modules, and program data. Each of the operating system, one or more application programs, other program modules, and program data or some combination thereof, may include an implementation of a networking environment. Program modules 942 generally carry out the functions and/or methodologies of embodiments of the invention as described herein.

Computer system/server 912 may also communicate with one or more external devices 914 such as a keyboard, a pointing device, a display 924, etc., one or more devices that enable a user to interact with computer system/server 912, and/or any devices (e.g., network card, modem, etc.) that enable computer system/server 912 to communicate with one or more other computing devices. Such communication can occur via Input/Output (I/O) interfaces 922. Still yet, computer system/server 912 can communicate with one or more networks such as a local area network (LAN), a general wide area network (WAN), and/or a public network (e.g., the Internet) via network adapter 920. As depicted, network adapter 920 communicates with the other components of computer system/server 912 via bus 918. It should be understood that although not shown, other hardware and/or software components could be used in conjunction with computer system/server 912. Examples, include, but are not limited to: microcode, device drivers, redundant processing units, external disk drive arrays, RAID systems, tape drives, and data archival storage systems, etc.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

We claim:

1. A system for forecasting prices of products, comprising:
a classification module capable of imputing a state indicator value for each price data from a time series history of a product, wherein a state is one of a promotional price state and a regular price state;
an extraction module capable of extracting a first price time series for the price data in the promotional state and extracting a second price time series for the price data in the regular state, and extracting a promotion duration time series from the time series history; and
a forecasting module capable of obtaining respective point forecasts for the extracted first price time series, the second price time series and the promotion duration time series, and combining the point forecasts for the extracted first and second price time series and the promotion duration time series to obtain a final price forecast.

2. The system according to claim 1, wherein the classification module is capable of using heuristic methods to impute the state indicator values.

3. The system according to claim 2, wherein the heuristic methods comprise clustering price levels and partitioning resulting clusters into the regular and promotional states.

4. The system according to claim 1, wherein the extraction module is capable of determining a number of time intervals for which the state indicator value is in the promotional state to extract the promotion duration time series.

5. The system according to claim 1, wherein the forecasting module separately obtains respective point forecasts for the extracted first price time series, the second price time series and the promotion duration time series.

6. The system according to claim 1, wherein the forecasting module, to combine the point forecasts for the extracted first and second price time series and the promotion duration time series, is capable of comparing the point forecast for the promotion duration time series to a value of a most recent promotion duration at a time instant where the final price forecast is being made.

7. The system according to claim 6, wherein:
the forecasting module is capable of determining if the point forecast for the promotion duration time series is greater than the value of the most recent promotion duration at the forecast time instant, and concluding that a next predicted price is in the promotion state, and is equal to a next point forecast of the first price time series; and
the forecasting module is capable of determining if the point forecast for the promotion duration time series is less than the value of the most recent promotion duration at the forecast time instant, and concluding that a next predicted price is in the regular state, and is equal to a next point forecast of the second price time series.

8. The system according to claim 1, wherein the extraction module is capable of extracting a time series of a magnitude of a promotional discount from the time series history.

9. An article of manufacture comprising a computer readable storage medium comprising program code tangibly embodied thereon, which when executed by a computer, performs method steps for forecasting prices of products, the method steps comprising:
obtaining a time series history of a price of a product;
imputing a state indicator value for each price data from the time series' history, wherein a state is one of a promotional price state and a regular price state;
extracting a first price time series for the price data in the promotional state and a second price time series for the price data in the regular state;
extracting a promotion duration time series from the time series history;
obtaining respective point forecasts for the extracted first price time series, the second price time series and the promotion duration time series; and
combining the point forecasts for the extracted first and second price time series and the promotion duration time series to obtain a final price forecast.

10. The article of manufacture according to claim 9, wherein extracting the promotion duration time series comprises determining a number of time intervals for which the state indicator value is in the promotional state.

11. The article of manufacture according to claim 9, wherein combining the point forecasts for the extracted first and second price time series and the promotion duration time series comprises comparing the point forecast for the promotion duration time series to a value of a most recent promotion duration at a time instant where the final price forecast is being made.

12. The article of manufacture according to claim 11, wherein:
if the point forecast for the promotion duration time series is greater than the value of the most recent promotion duration at the forecast time instant, a next predicted price is in the promotion state, and is equal to a next point forecast of the first price time series; and
if the point forecast for the promotion duration time series is less than the value of the most recent promotion duration at the forecast time instant, a next predicted price is in the regular state, and is equal to a next point forecast of the second price time series.
